(19) United States
(12) Patent Application Publication
(10) Pub. No.: US 2026/0296774 A1
(43) Pub. Date: Oct. 1, 2026

(54) Waste Containment Bag With Tubular Compression Closure Assembly

(71) Applicant: PacTec, Inc., Clinton, LA (US)

(72) Inventors: Michael R. Schilling, Clinton, LA (US); Troy Town, Clinton, LA (US)

(21) Appl. No.: 19/578,561

(22) Filed: Mar. 25, 2026

Related U.S. Application Data
(60) Provisional application No. 63/777,392, filed on Mar. 25, 2025.

(51) Int. Cl. B65F 1/00

(52) U.S. Cl. CPC B65F 1/002

(57) ABSTRACT

A waste containment bag includes a multi-layer container having an outer shell and an inner liner disposed within the outer shell. The outer shell defines a bottom, sidewalls, and a top having a closeable lid. The inner liner includes a spout opening on a top portion thereof adjacent to the closeable lid. A tubular compression closure assembly is configured to seal the spout opening of the inner liner. The tubular compression closure assembly comprises an inner rod having a circular cross-section, a slotted resilient sleeve clamp having a circular cross-section and a longitudinal slot formed therein, and first and second end caps. The sleeve clamp is adapted to mate to the inner rod and apply a compressive force. The first and second end caps are configured to secure the sleeve clamp to the inner rod.

### CROSS-REFERENCE TO RELATED APPLICATIONS

This application claims priority to U.S. Provisional Application No. 63/777,392, filed Mar. 25, 2025, which is hereby incorporated by reference in its entirety.

### BACKGROUND

Hazardous waste, including industrial catalyst waste, presents potential environmental and health risks. The packaging and disposal of such waste follows strict regulatory guidelines to ensure safety and compliance. Waste catalysts are oftentimes stored and transported in DOT-approved containers, such as drums, intermediate bulk containers (IBCs), or specialized hazardous waste containers. If non-recyclable, catalysts are disposed of in hazardous waste landfills.

The selection of approved containers for chemical waste catalysts depends on the catalyst's physical and chemical properties, hazardous classification, and applicable regulations. Common types of approved containers used for packaging and transporting chemical waste catalysts include UN-rated steel drums, metal boxes, polyethylene (HDPE) drums, intermediate bulk containers (IBCs), flexible intermediate bulk containers (FIBCs), and other specialty, custom-designed containers. All containers are UN/DOT-rated for hazardous materials and are compatible with the waste catalyst material to prevent reactions or leakage.

An overarching requirement for catalyst waste transport and disposal is to prevent spills, leaks, dust release, or contamination during handling and transport. For this reason, soft-sided waste containment bags oftentimes use multi-layered reinforced materials to prevent punctures. The closure mechanism for the containment bag also resists leakages and dust release.

Conventional self-standing waste containment bags used for transporting and disposing of catalyst waste are constructed of multiple polymeric layers. The top panel of the outer shell may utilize a zipper closure to allow access to the inner liner. The inner liner has a spout top to accommodate the transfer of catalyst waste into the container. A screw cap assembly is oftentimes used with such conventional waste containment bags. The screw cap assembly comprises a threaded adapter flange that is slid over the liner's spout. After the containment bag is filled, the inner liner's spout is folded back over the threads of the adapter flange, the screw cap is mated to the adapter flange to seal the inner liner, and then the top panel of the outer shell is closed.

Conventional self-standing waste containment bags using the foregoing screw cap design are adept at preventing spills and leaks when the screw cap assembly is properly assembled. However, in practice, the screw cap design can be both inefficient and prone to user error when securing the screw cap to the threaded adapter flange, resulting in containment bags that lack the requisite seal. Accordingly, there remains a desire for improved closure mechanisms that provide a secure seal and can be installed in the field in an efficient and straightforward manner.

### SUMMARY

The present disclosure provides an improved waste containment bag that facilitates reliable sealing of an inner liner using a tubular compression closure assembly. The waste containment bag includes a multi-layer container having an outer shell and an inner liner disposed within the outer shell. The outer shell defines a bottom, sidewalls, and a top having a closeable lid. The inner liner includes a spout opening on a top portion thereof adjacent to the closeable lid. The waste containment bag further includes a tubular compression closure assembly configured to seal the spout opening of the inner liner. The tubular compression closure assembly comprises an inner rod having a circular cross-section, a slotted resilient sleeve clamp having a circular cross-section, and first and second end caps. The slotted resilient sleeve clamp is adapted to mate to the inner rod and apply a compressive force. The first and second end caps are configured to secure the sleeve clamp to the inner rod.

According to other aspects of the present disclosure, the waste containment bag may include one or more of the following features. The sleeve clamp may have a longitudinal slot formed therein to facilitate the sleeve clamp being slid over the inner rod. The sleeve clamp may be constructed of a resilient material. The resilient material may be an elastomeric plastic. The elastomeric plastic may be selected from the group consisting of thermoplastic elastomers, polyethylene(s), polypropylene, and nylon. The sleeve clamp may have an inner diameter that is approximately the same as an outer diameter of the inner rod. The outer shell may be constructed of a coated non-woven polymeric material. The coated non-woven polymeric material may be a non-woven polypropylene having a weight of 8 to 30 oz. The multi-layer container may further comprise cardboard sidewall inserts retained within pockets on an inner side of each of the sidewalls. The pockets may be constructed of woven polypropylene. The closeable lid may be releasably secured to the top using a zipper closure. The waste containment bag may further comprise lift loops attached to corners of the multi-layer container. The inner liner may be constructed of polyethylene with a thickness of 9 mils. The inner liner may be secured to an inner side of the outer shell via sewing, glue, or tabbed connections.

According to another aspect of the present disclosure, a method of sealing a waste containment bag is provided. The method includes providing a waste containment bag having a multi-layer container with an outer shell and an inner liner disposed within the outer shell. The inner liner includes a spout opening on a top portion thereof. The method further includes wrapping the spout opening around an inner rod of a tubular compression closure assembly. The inner rod has a circular cross-section. The method further includes aligning a longitudinal slot of a slotted resilient sleeve clamp with the inner rod. The sleeve clamp has a circular cross-section. The method further includes pushing the sleeve clamp onto the inner rod to apply a compressive force against the spout opening wrapped around the inner rod, thereby sealing the inner liner. The method further includes securing the sleeve clamp to the inner rod by sliding first and second end caps over the sleeve clamp. The method may further comprise closing a closeable lid of the outer shell after sealing the inner liner.

According to another aspect of the present disclosure, a tubular compression closure assembly for sealing a spout opening of an inner liner of a waste containment bag is provided. The tubular compression closure assembly includes an inner rod having a circular cross-section and configured to receive the spout opening wrapped therearound. The tubular compression closure assembly further includes a slotted resilient sleeve clamp having a circular cross-section and a longitudinal slot formed therein. The sleeve clamp is adapted to snap-fit over the inner rod and apply a compressive force against the spout opening wrapped around the inner rod. The tubular compression closure assembly further includes first and second end caps configured to couple to ends of the sleeve clamp to secure the sleeve clamp to the inner rod and prevent accidental detachment.

The above summary is not intended to describe each illustrated embodiment or every possible implementation. These and other features, aspects, and advantages of the present invention will become better understood with regard to the following description, appended claims, and accompanying drawings.

### BRIEF DESCRIPTION OF FIGURES

The accompanying figures, together with the detailed description below, are incorporated in and form part of the specification, serve to illustrate further various exemplary embodiments and to explain various principles and advantages in accordance with the present invention:

FIG. 1 illustrates a front perspective view of a prior art waste containment bag, according to aspects of the present disclosure.

FIG. 2A illustrates a front perspective view of a waste containment bag with a tubular compression closure assembly, according to aspects of the present disclosure.

FIG. 2B illustrates a front perspective view of the waste containment bag of FIG. 2A with a closeable lid in a closed position, according to aspects of the present disclosure.

FIG. 3A illustrates a front perspective view of the waste containment bag of FIG. 2A with a spout opening extended to accommodate installation of the tubular compression closure assembly, according to aspects of the present disclosure.

FIG. 3B illustrates a front perspective view of the waste containment bag of FIG. 2A showing an initial stage of wrapping a spout around an inner rod, according to aspects of the present disclosure.

FIG. 3C illustrates a front perspective view of the waste containment bag of FIG. 2A showing an intermediate stage of wrapping the spout around the inner rod, according to aspects of the present disclosure.

FIG. 3D illustrates a front perspective view of the waste containment bag of FIG. 2A showing a sleeve clamp snap-fitted over the inner rod, according to aspects of the present disclosure.

FIG. 3E illustrates a front perspective view of the waste containment bag of FIG. 2A showing end caps coupled to the sleeve clamp, according to aspects of the present disclosure.

FIG. 4 illustrates a front perspective view of a first alternative embodiment of a waste containment bag with a tubular compression closure assembly, according to aspects of the present disclosure.

FIG. 5 illustrates a front perspective view of a second alternative embodiment of a waste containment bag with multiple tubular compression closure assemblies, according to aspects of the present disclosure.

FIG. 6 illustrates a front perspective view of a third alternative embodiment of a waste containment bag with a tubular compression closure assembly, according to aspects of the present disclosure.

FIG. 7 illustrates a front perspective view of a fourth alternative embodiment of a waste containment bag with a tubular compression closure assembly, according to aspects of the present disclosure.

### DETAILED DESCRIPTION

Detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting, but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

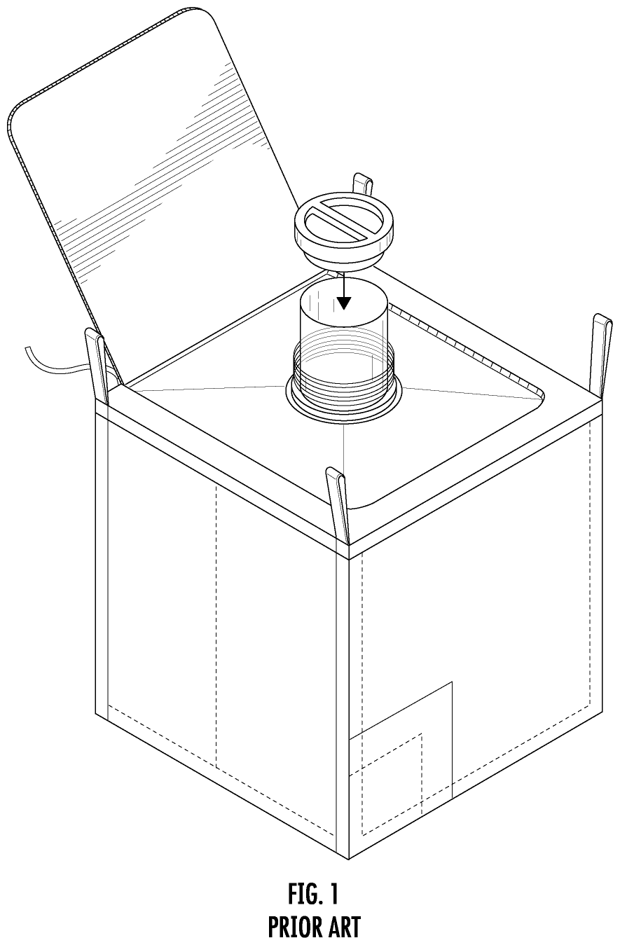

Referring to FIG. 1, a prior art waste containment bag suitable for containing hazardous waste is shown. The prior art waste containment bag is a conventional, self-standing container constructed of multiple polymeric layers. The prior art waste containment bag includes a soft-sided outer shell having a bottom, four sidewalls, and a top portion. The top panel of the outer shell features a closeable lid that may utilize a zipper closure to allow access to the interior of the container. Lift loops are attached to the corners of the container to facilitate handling and transport.

With continued reference to FIG. 1, an inner liner of the prior art waste containment bag has a spout top positioned on an upper portion of the inner liner to accommodate transfer of catalyst waste or other hazardous materials into the container. A screw cap assembly is positioned above the spout opening. The screw cap assembly comprises a threaded adapter flange that is configured to be slid over the spout of the inner liner. After the containment bag is filled, the spout of the inner liner is folded back over threads of the threaded adapter flange, and a screw cap is mated to the threaded adapter flange to seal the inner liner. The top panel of the outer shell is then closed to complete the sealing process.

The prior art waste containment bag using the screw cap design may prevent spills and leaks when the screw cap assembly is properly assembled. However, in practice, the screw cap design presents challenges in field applications. The screw cap design may be inefficient due to the multiple steps involved in securing the screw cap to the threaded adapter flange. The screw cap design may also be susceptible to user error when securing the screw cap to the threaded adapter flange, which may result in containment bags that lack a proper seal. Improper assembly of the screw cap assembly may lead to leakages and dust release during handling and transport of the waste containment bag.

The present disclosure relates to a waste containment bag featuring a tubular compression closure assembly for sealing an opening of the bag, thereby addressing the inefficiencies and user-error risks associated with conventional screw-cap closure designs. The waste containment bag may include a multi-layer container having a soft-sided construction with a bottom, sidewalls, and a closeable top. In some embodiments, the multi-layer container includes an outer shell and an inner liner disposed within the outer shell, with the inner liner including a spout opening on a top portion thereof to accommodate transfer of waste material into the container. In other embodiments, the waste containment bag may be configured as an envelope-style bag having a generally planar construction with an open top edge, rather than a spout opening, the open top edge being sealable using the tubular compression closure assembly.

The tubular compression closure assembly provides a sealing mechanism that enables an opening of the waste containment bag to be sealed in an efficient and reliable manner across multiple bag form factors. The tubular compression closure assembly may be configured to seal either a spout opening of an inner liner or an open top edge of an envelope-style bag, and may include an inner rod, a slotted resilient sleeve clamp, and one or more end caps. In operation, liner material adjacent the opening is wrapped around the inner rod, and the sleeve clamp is engaged with the inner rod to apply a compressive force against the wrapped liner material, thereby sealing the opening. The sleeve clamp may be coupled to the inner rod using an align-and-push engagement method, and the end caps may secure the sleeve clamp to the inner rod and prevent accidental detachment during handling and transport of the waste containment bag.

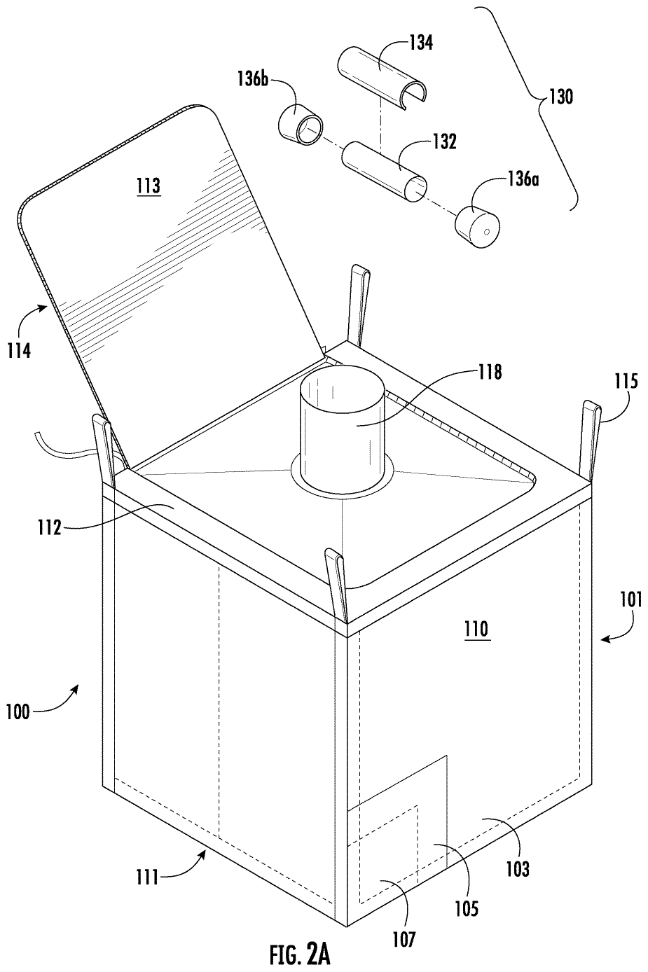

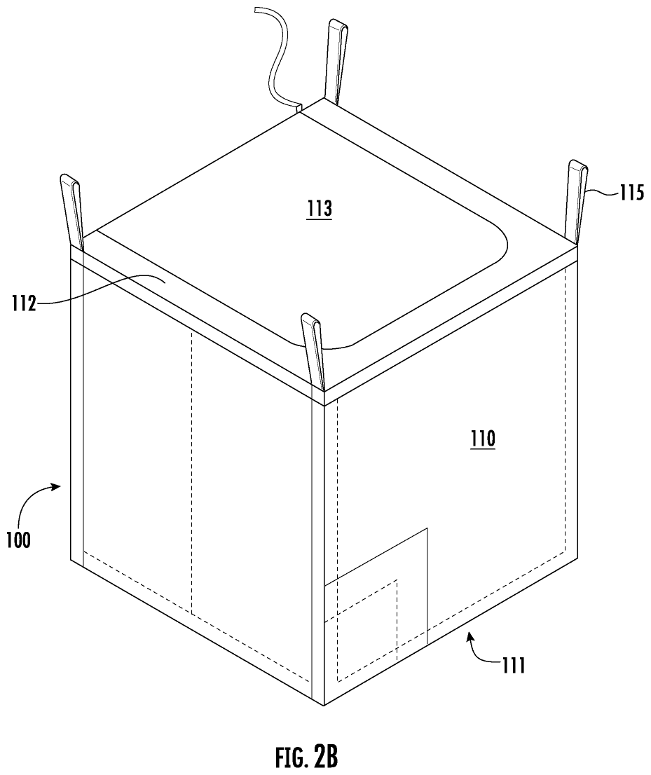

Referring to FIG. 2A, a waste containment bag 100 having a closure system is shown. The waste containment bag 100 may include a multi-layer container 101 and a tubular compression closure assembly 130 for sealing an inner liner of the multi-layer container 101.

The multi-layer container 101 may comprise an outer shell 103, cardboard sidewall inserts 105, and an inner liner 107. The outer shell 103 may define a bottom 111, sidewalls 110, and a top 112 having a closeable lid 113. The outer shell 103 may be constructed out of a coated non-woven polymeric material, such as a non-woven polypropylene having a weight of 8 to 30 oz. In some cases, the outer shell 103 may be constructed out of other polymeric or fabric-based materials.

With continued reference to FIG. 2A, pockets may be sewn or otherwise attached to an inner side of each of the sidewalls 110 for retaining the cardboard sidewall inserts 105. The cardboard sidewall inserts 105 may allow the multi-layer container 101 to be a self-standing or self-supporting containment bag. The pockets may be constructed out of 3 oz woven polypropylene. In some cases, the pockets may be constructed out of other polymeric or fabric-based materials. In some cases, a spring steel stiffener, such as the ones disclosed in U.S. Pat. No. 11,597,593, may be utilized in lieu of cardboard sidewall inserts 105.

The closeable lid 113 may be releasably secured to the top 112 using a zipper closure 114. In some cases, other closing mechanisms may be used, such as hook-and-loop fasteners, ties, or other means. Lift loops 115 may be attached to four corners of the multi-layer container 101. The lift loops 115 may be constructed out of webbing rated at 10,000 lbs. or greater. In some cases, the lift loops 115 may be replaced with a lift sling system that is slidably coupled to the sidewalls 110.

The inner liner 107 may be disposed within the outer shell 103. The inner liner 107 may include a spout opening 118 on a top portion of the inner liner 107 adjacent to the closeable lid 113. The spout opening 118 may extend vertically from the top 112 of the multi-layer container 101. The inner liner 107 may be constructed out of polyethylene with a thickness of 9 mils. In some cases, the inner liner 107 may be constructed out of other polymeric materials. The inner liner 107 may be secured to an inner side of the outer shell 103 via sewing, glue, or tabbed connections.

As further shown in FIG. 2A, the tubular compression closure assembly 130 may be positioned above the waste containment bag 100 and may be configured to seal the spout opening 118 of the inner liner 107. The tubular compression closure assembly 130 may comprise an inner rod 132 having a circular cross-section, a sleeve clamp 134 having a circular cross-section with a longitudinal slot, and a first end cap 136a and a second end cap 136b. The sleeve clamp 134 may be adapted to mate to the inner rod 132 and apply a compressive force. The first end cap 136a and the second end cap 136b may be configured to secure the sleeve clamp 134 to the inner rod 132, preventing accidental detachment.

The sleeve clamp 134 may be constructed of a resilient material, such as elastomeric plastics including thermoplastic elastomers, polyethylene, polypropylene, or nylon. The sleeve clamp 134 may have an inner diameter that is approximately the same as an outer diameter of the inner rod 132. The longitudinal slot formed in the sleeve clamp 134 may facilitate the sleeve clamp 134 being slid over the inner rod 132, with a compression fit functioning to secure the sleeve clamp 134 to the inner rod 132.

Referring to FIG. 2B, the waste containment bag 100 is shown with the outer shell in a closed position. The waste containment bag 100 includes the sidewalls 110 that extend vertically from the bottom 111 to the top 112. The closeable lid 113 is shown in a closed configuration, covering an interior of the multi-layer container 101. The lift loops 115 are attached to the four corners of the waste containment bag 100, extending upward from the top 112 to facilitate lifting and transport of the waste containment bag 100. The closed configuration of the closeable lid 113 may provide containment of contents within the waste containment bag 100 after the inner liner 107 has been sealed using the tubular compression closure assembly 130.

The outer shell may be constructed out of a coated non-woven polymeric material. In some cases, the outer shell may be constructed out of a non-woven polyester (NWPET) or non-woven polypropylene having a weight of 8 to 30 oz. The coated non-woven polymeric material may provide durability and resistance to punctures during handling and transport of the waste containment bag.

Pockets may be sewn or otherwise attached to an inner side of each of the sidewalls for retaining cardboard inserts. The cardboard inserts retained within the pockets may allow the container to be a self-standing or self-supporting containment bag. The pockets may be constructed out of 3 oz woven polypropylene (WPP). In some cases, the pockets may be constructed out of other polymeric or fabric-based materials.

The closeable lid may be releasably secured to the top using a zipper closure. The zipper closure may allow access to the interior of the container for filling operations and for installation of the tubular compression closure assembly. In some cases, other closing mechanisms may be used for the closeable lid. Alternative closing mechanisms may include hook-and-loop fasteners, ties, or other means. The closing mechanism may be selected based on the application requirements and the type of waste material to be contained within the waste containment bag.

Referring to FIG. 2A, lift loops 115 may be attached to four corners of the multi-layer container 101. The lift loops 115 may facilitate lifting and transport of the waste containment bag 100 when the waste containment bag 100 is filled with waste material. The lift loops 115 may be constructed out of webbing rated at 10,000 lbs. or greater. The webbing strength rating may allow the lift loops 115 to support the weight of the waste containment bag 100 and the contents contained therein during lifting operations.

A top band may extend around the top of the sidewalls 110 to help secure and reinforce the lift loops 115. The top band may distribute lifting forces across the sidewalls 110 of the multi-layer container 101. The top band may be attached to the outer shell 103 at locations where the lift loops 115 are coupled to the multi-layer container 101.

In some cases, the lift loops 115 may be replaced with a lift sling system. The lift sling system may be slidably coupled to the sidewalls 110 of the waste containment bag 100. The lift sling system may provide an alternative configuration for lifting and transport of the waste containment bag 100. The slidable coupling of the lift sling system to the sidewalls 110 may allow adjustment of the lift sling system relative to the waste containment bag 100.

Referring to FIG. 2A, the inner liner 107 may be disposed within the outer shell 103. The inner liner 107 may be positioned to conform to an interior shape defined by the outer shell 103 and the cardboard sidewall inserts 105. The inner liner 107 may function to contain waste material within the waste containment bag 100 and to prevent contact between the waste material and the outer shell 103.

The inner liner 107 may include the spout opening 118 on a top portion of the inner liner 107. The spout opening 118 may be positioned adjacent to the closeable lid 113. The spout opening 118 may extend upwardly from the top 112 of the multi-layer container 101 to accommodate transfer of waste material into the inner liner 107. The spout opening 118 may provide an access point for filling the inner liner 107 with waste material and may be configured to receive the tubular compression closure assembly 130 for sealing the inner liner 107.

The inner liner 107 may be constructed out of polyethylene (PE). The polyethylene material may provide chemical resistance and flexibility for containing waste materials. The inner liner 107 may have a thickness of 9 mils. The 9 mil thickness may provide a balance between flexibility for conforming to the interior of the outer shell 103 and durability for containing waste materials during handling and transport.

The inner liner 107 may be secured to an inner side of the outer shell 103. In some cases, the inner liner 107 may be secured to the outer shell 103 via sewing. Sewing may provide a mechanical attachment between the inner liner 107 and the outer shell 103. In some cases, the inner liner 107 may be secured to the outer shell 103 via glue. Glue may provide an adhesive bond between the inner liner 107 and the outer shell 103. In some cases, the inner liner 107 may be secured to the outer shell 103 via tabbed connections. Tabbed connections may provide discrete attachment points between the inner liner 107 and the outer shell 103. The method of securing the inner liner 107 to the outer shell 103 may be selected based on manufacturing considerations and performance requirements for the waste containment bag 100.

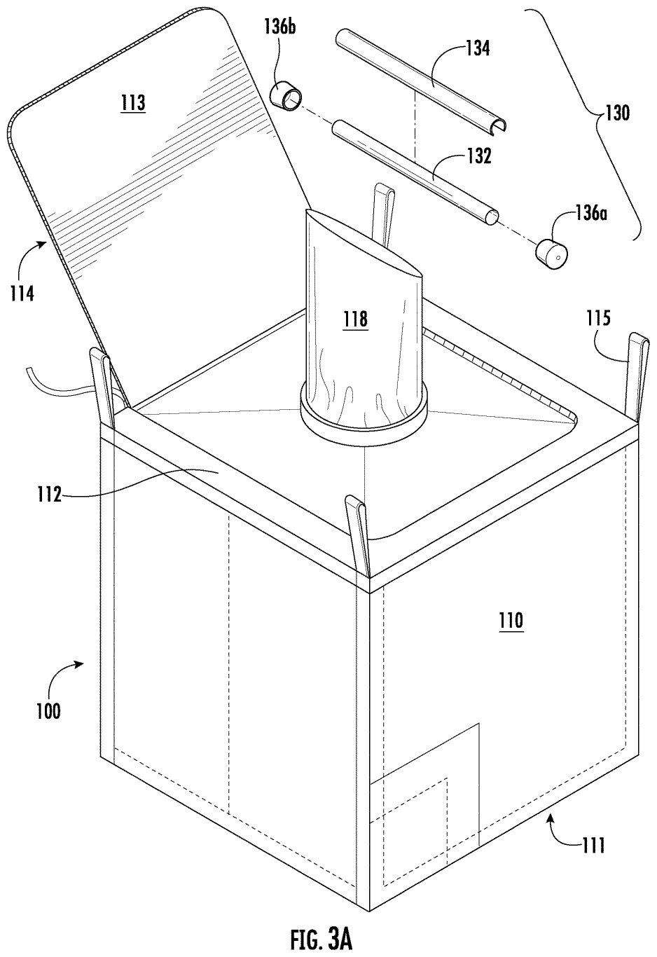

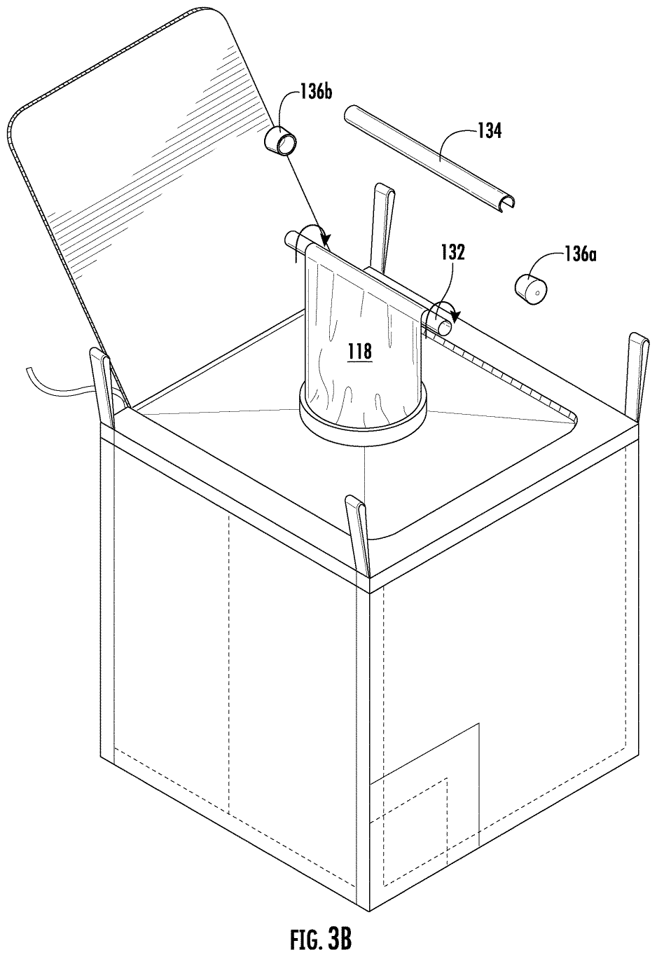

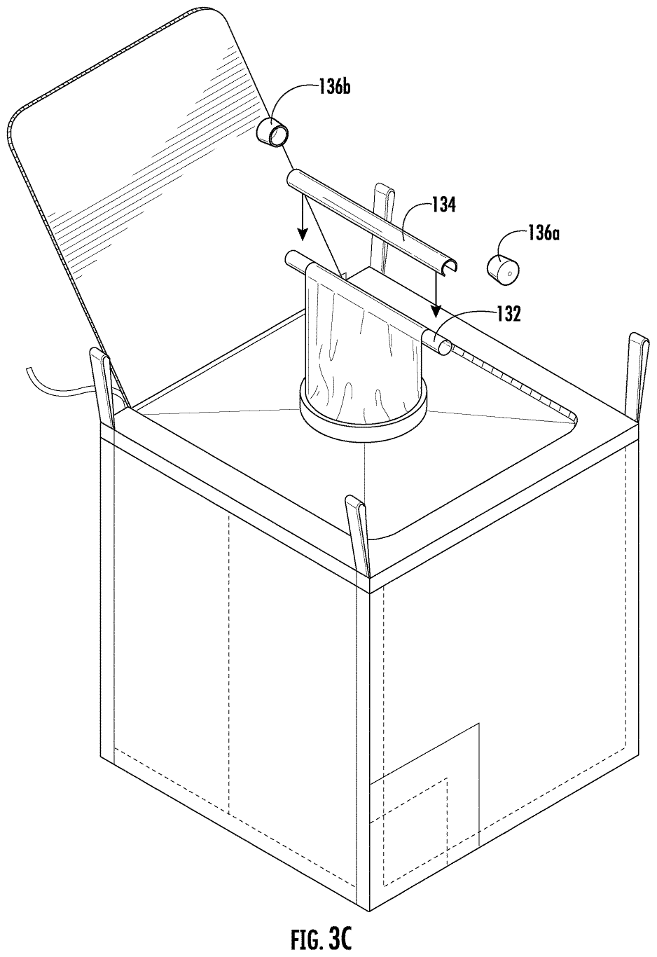

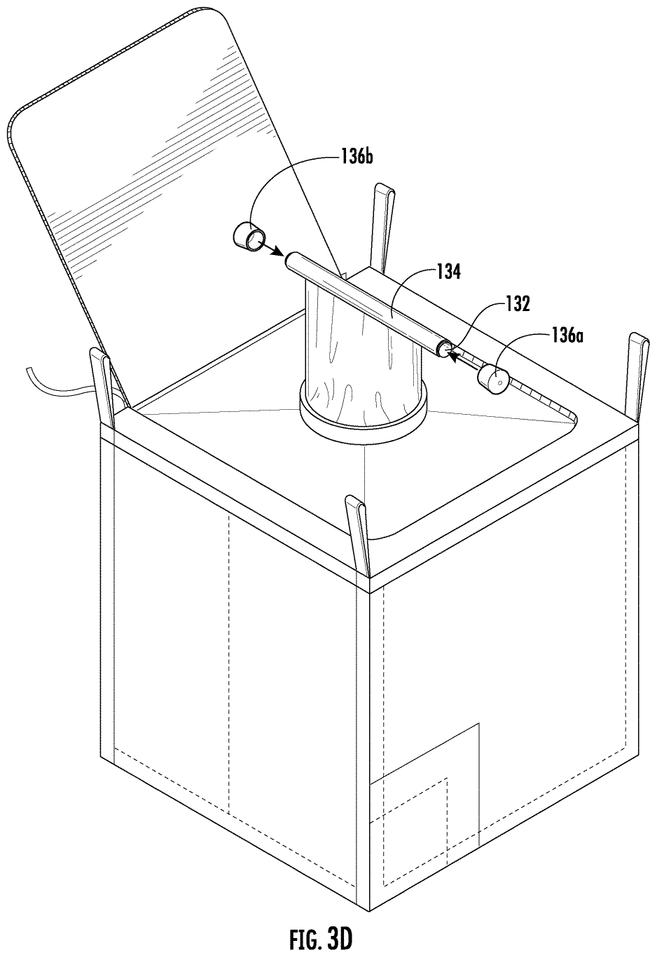

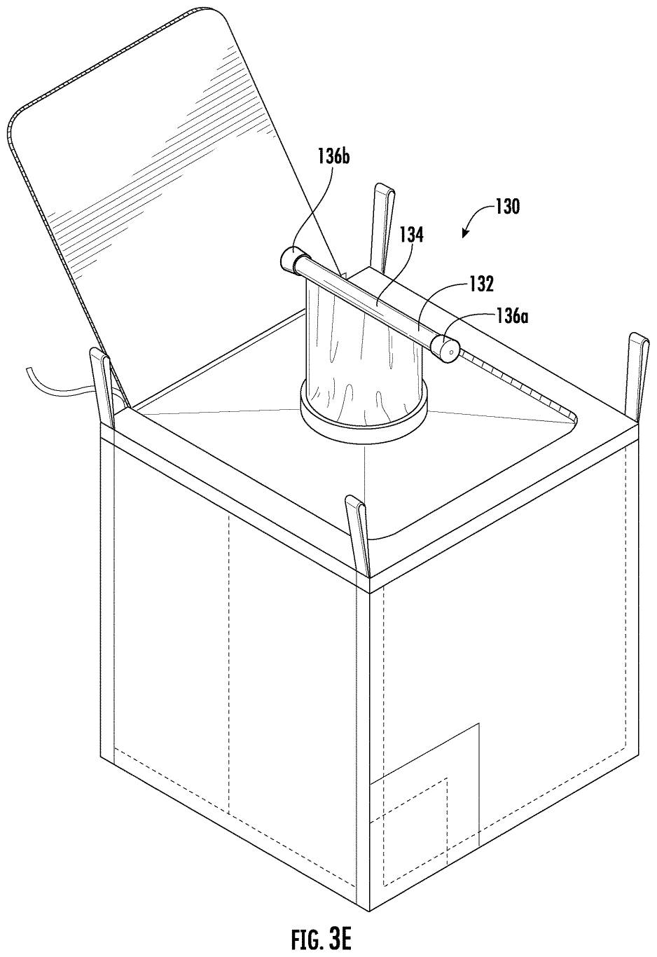

Referring to FIGS. 3A-3E, successive stages of using the tubular compression closure assembly 130 to seal the inner liner 107 of the waste containment bag 100 are illustrated. The components of the tubular compression closure assembly 130 are the same as those described above with reference to FIGS. 2A-2B.

In use, the spout opening 118 of the inner liner 107 is extended upward, and the spout material is wrapped around the inner rod 132, as shown in FIGS. 3A-3C. Once the spout material is wrapped around the inner rod 132, the slotted resilient sleeve clamp 134 is aligned with the inner rod 132 and engaged therewith using an align-and-push engagement method. As the sleeve clamp 134 is pushed over the inner rod 132, the resilient material of the sleeve clamp 134 deforms to allow engagement and then applies a compressive force against the wrapped spout material, thereby sealing the inner liner 107, as shown in FIG. 3D.

After the sleeve clamp 134 is engaged with the inner rod 132, the first and second end caps 136a, 136b are coupled to opposite ends of the sleeve clamp 134 to secure the sleeve clamp 134 to the inner rod 132 and prevent accidental detachment during handling and transport, as shown in FIG. 3E. In this fully assembled configuration, the tubular compression closure assembly 130 provides a sealed closure for the inner liner 107 of the waste containment bag 100.

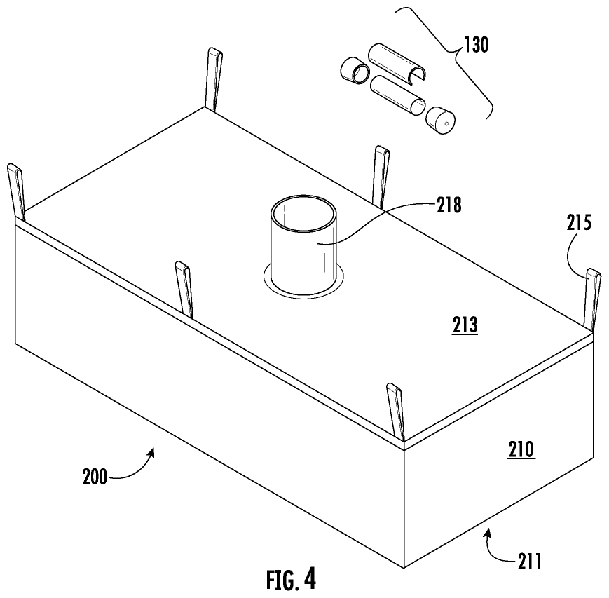

Referring to FIG. 4, a first alternative embodiment of a waste containment bag having a closure system is illustrated. FIG. 4 depicts a large-volume waste containment bag 200 that is substantially similar in construction and operation to the waste containment bag 100 described above with respect to FIGS. 2A-3E, except that the waste containment bag 200 is configured in a larger format to accommodate increased volumes of waste material. The large-volume waste containment bag 200 includes a bottom 211, sidewalls 210 defining an interior volume, lift loops 215 for handling and transport, and at least one spout opening 218 positioned on a top surface of the bag. The spout opening 218 is configured to receive the tubular compression closure assembly 130, which may be installed using the same sealing process described above with reference to FIGS. 3A-3E.

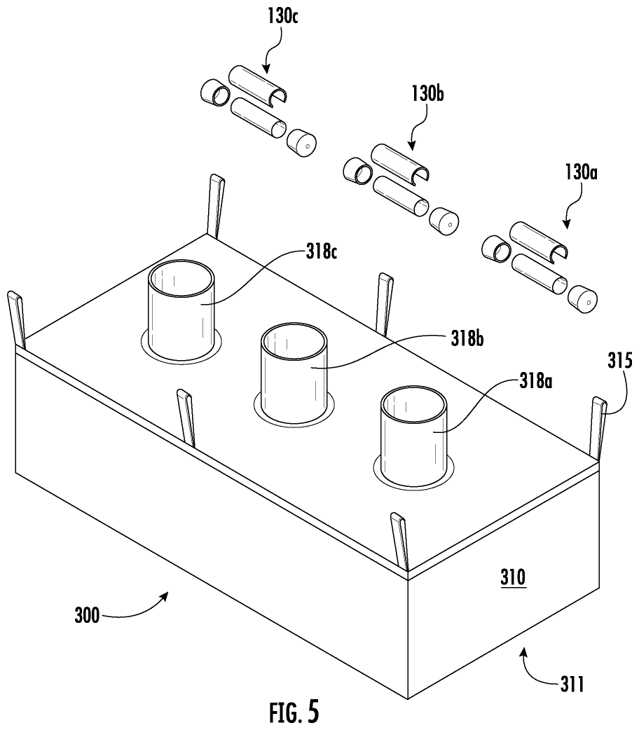

Referring to FIG. 5, a second alternative embodiment of a waste containment bag having a closure system is illustrated. FIG. 5 depicts a waste containment bag 300 that is generally similar in size and construction to the large-volume waste containment bag 200 of FIG. 4, but includes multiple spout openings for accommodating multiple filling points. As shown, the waste containment bag 300 includes three spout openings 318a, 318b, and 318c, each configured to receive a respective tubular compression closure assembly 130a, 130b, and 130c. Each tubular compression closure assembly may be installed and operated in the same manner described above, such that each spout opening is independently sealed by wrapping the spout material around a corresponding inner rod, engaging a sleeve clamp to apply compressive force, and securing the sleeve clamp with end caps. This configuration allows the waste containment bag 300 to support multiple independently sealed filling locations while maintaining the same closure mechanism and sealing principles.

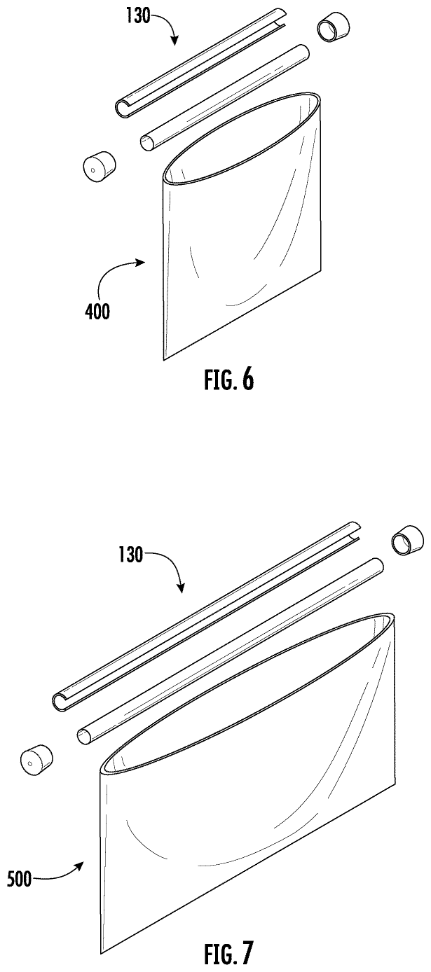

FIGS. 6 and 7 depict a third alternative inner liner 400 and a fourth alternative inner liner 500, respectively, each configured as an envelope-style inner liner. Although an outer shell is not depicted in FIGS. 6 and 7, it should be understood that each envelope-style inner liner 400, 500 is configured to be received within a soft-sided outer shell, which may be provided in a variety of shapes and sizes, as described above.

As shown in FIG. 6, the third alternative inner liner 400 has a generally flat, envelope-like construction, with side edges that may converge toward a bottom portion of the liner. This envelope-style configuration provides an alternative inner-liner form factor compared to the spout-top inner liner described above with reference to waste containment bags 100, 200, and 300.

A tubular compression closure assembly 130 is positioned at a top opening of the third alternative inner liner 400 and functions to seal the opening by applying compressive force to liner material wrapped around an inner rod, as described above. The tubular compression closure assembly 130 includes an inner rod 132, a slotted resilient sleeve clamp 134, and first and second end caps 136a, 136b, which cooperate to retain the sleeve clamp on the inner rod and prevent accidental detachment.

As shown in FIG. 7, the fourth alternative inner liner 500 is also configured as an envelope-style inner liner and may have dimensional proportions that differ from those of the third alternative inner liner 400. A tubular compression closure assembly 130 is similarly positioned at a top opening of the fourth alternative inner liner 500.

The tubular compression closure assembly 130 may be used with envelope-style inner liners of varying sizes and shapes, which may be installed within outer shells of corresponding or different configurations. In each case, sealing may be accomplished by wrapping liner material adjacent a top opening around the inner rod 132, engaging the sleeve clamp 134 over the inner rod to apply compressive force, and securing the sleeve clamp with the end caps 136a, 136b.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A waste containment bag, comprising:
a multi-layer container having an outer shell and an inner liner disposed within the outer shell, the outer shell defining a bottom, sidewalls, and a top having a closeable lid, the inner liner including a spout opening on a top portion thereof adjacent to the closeable lid; and
a tubular compression closure assembly configured to seal the spout opening of the inner liner, the tubular compression closure assembly comprising:
an inner rod having a circular cross-section;
a slotted resilient sleeve clamp having a circular cross-section and a longitudinal slot formed therein, the sleeve clamp adapted to mate to the inner rod and apply a compressive force; and
first and second end caps configured to secure the sleeve clamp to the inner rod.

2. The waste containment bag of claim 1, wherein the sleeve clamp is constructed of a resilient material.

3. The waste containment bag of claim 2, wherein the resilient material is an elastomeric plastic.

4. The waste containment bag of claim 3, wherein the elastomeric plastic is selected from the group consisting of thermoplastic elastomers, polyethylene, polypropylene, and nylon.

5. The waste containment bag of claim 1, wherein the sleeve clamp has an inner diameter that is approximately the same as an outer diameter of the inner rod.

6. The waste containment bag of claim 1, wherein the outer shell is constructed of a coated non-woven polymeric material.

7. The waste containment bag of claim 6, wherein the coated non-woven polymeric material is a non-woven polypropylene having a weight of 8 to 30 oz.

8. The waste containment bag of claim 1, wherein the multi-layer container further comprises cardboard sidewall inserts retained within pockets on an inner side of each of the sidewalls.

9. The waste containment bag of claim 8, wherein the pockets are constructed of woven polypropylene.

10. The waste containment bag of claim 1, wherein the closeable lid is releasably secured to the top using a zipper closure.

11. The waste containment bag of claim 1, further comprising lift loops attached to corners of the multi-layer container.

12. A method of sealing a waste containment bag, comprising:
providing a waste containment bag having a multi-layer container with an outer shell and an inner liner disposed within the outer shell, the inner liner including a spout opening on a top portion thereof;
wrapping the spout opening around an inner rod of a tubular compression closure assembly, the inner rod having a circular cross-section;
aligning a longitudinal slot of a slotted resilient sleeve clamp with the inner rod, the sleeve clamp having a circular cross-section;
pushing the sleeve clamp onto the inner rod to apply a compressive force against the spout opening wrapped around the inner rod, thereby sealing the inner liner; and
securing the sleeve clamp to the inner rod by sliding first and second end caps over the sleeve clamp.

13. The method of claim 12, wherein the sleeve clamp is constructed of a resilient material having an inner diameter that is approximately the same as an outer diameter of the inner rod.

14. The method of claim 13, wherein the resilient material is an elastomeric plastic selected from the group consisting of thermoplastic elastomers, polyethylene, polypropylene, and nylon.

15. The method of claim 12, further comprising closing a closeable lid of the outer shell after sealing the inner liner.

16. The method of claim 12, wherein the outer shell defines a bottom, sidewalls, and a top having the closeable lid, and wherein the spout opening is positioned adjacent to the closeable lid.

17. A tubular compression closure assembly for sealing an opening of an inner liner of a waste containment bag, comprising:
an inner rod having a circular cross-section and configured to receive the spout opening wrapped therearound;
a slotted resilient sleeve clamp having a circular cross-section and a longitudinal slot formed therein, the sleeve clamp adapted to snap-fit over the inner rod and apply a compressive force against the spout opening wrapped around the inner rod; and
first and second end caps configured to couple to ends of the sleeve clamp to secure the sleeve clamp to the inner rod and prevent accidental detachment.

18. The tubular compression closure assembly of claim 17, wherein the sleeve clamp is constructed of an elastomeric plastic selected from the group consisting of thermoplastic elastomers, polyethylene, polypropylene, and nylon.

19. The tubular compression closure assembly of claim 18, wherein the sleeve clamp has an inner diameter that is approximately the same as an outer diameter of the inner rod.

20. The tubular compression closure assembly of claim 17, wherein the longitudinal slot extends along a length of the sleeve clamp to facilitate the sleeve clamp being slid over the inner rod.
